(19) United States
(12) Patent Application Publication
(10) Pub. No.: US 2025/0269246 A1
(43) Pub. Date: Aug. 28, 2025

(54) Pickleball Ball Holder

(71) Applicant: Ofinno, LLC, Reston, VA (US)

(72) Inventor: Esmael Hejazi DINAN, McLean, VA (US)

(21) Appl. No.: 19/063,229

(22) Filed: Feb. 25, 2025

Related U.S. Application Data
(60) Provisional application No. 63/558,110, filed on Feb. 26, 2024.

(51) Int. Cl. A63B 47/00; A63B 102/08; F16M 13/02

(52) U.S. Cl. CPC A63B 47/00; F16M 13/02; A63B 2102/08

(57) ABSTRACT

Apparatuses for organizing pickleball balls are described. An example pickleball ball holder comprises a surface board, and one or more projections installed on the surface board to extend outwardly from the surface board. A projection of the one or more projections is configured to hold a pickleball ball by being positioned to penetrate in at least one aperture of the pickleball ball. The thickness of the projection is smaller than the diameter of the at least one of the apertures, and the projection is configured to loosely enter the at least one aperture without substantial friction.

### CROSS REFERENCE TO RELATED APPLICATIONS

This application claims priority to U.S. Provisional Patent Application No. 63/558,110 filed Feb. 26, 2024, the entire content of which is herein incorporated by reference.

### FIELD

This disclosure related to pickleball, and more particularly to apparatuses for organizing or storing pickleball balls.

### BACKGROUND

When playing the sport of pickleball, users hit pickleball balls with pickleball paddles. In a pickleball arena where there are multiple pickleball courts, it is not safe and/or convenient to have the balls spread around the court. There is a need to store pickleball balls in one or more places so that players can use them for playing the game.

Typically, a basket, a bucket or a tube shaped pickleball ball holder is used to store or hold pickleballs. Players can also hold pickleball balls in their pockets or sport apparel so that they can store and carry pickleball balls as they move around. However, the current solutions are inconvenient to use.

Therefore, improved pickleball ball holders are desired.

### BRIEF DESCRIPTION OF THE DRAWINGS

Some features are shown by way of example, and not by limitation, in the accompanying drawings. In the drawings, like numerals may reference similar elements.

FIG. 1A shows an example pickleball court, in which embodiments of the present disclosure may be applied.

FIG. 1B shows another view of a pickleball court.

FIG. 2 shows an example pickleball ball and its apertures.

FIG. 3 shows an example pickleball ball holder that may be used for holding pickleball balls according to some embodiments of this disclosure.

FIG. 4 shows another example pickleball ball holder that may be used for holding pickleball balls according to some embodiments of this disclosure.

FIG. 5 shows another pickleball ball holder according to some embodiments of the present disclosure.

FIG. 6 illustrates an example projection that can be installed on a pickleball ball holder board according to some embodiments of the present disclosure.

### DETAILED DESCRIPTION OF EXAMPLE EMBODIMENTS

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

This disclosure relates to “Pickleball,” a game that has in recent years seen a massive increase in popularity among all age groups of players, including among senior citizens. Pickleball is a game that can be described as combining aspects of tennis, badminton, and ping-pong. It is played on a badminton-sized court, with paddles and a ball similar to a wiffle ball, but slightly smaller in size. The net used in pickleball is similar to a tennis net in some ways, but is lowered at the center.

Pickleball has recently become very popular and is played both indoors and outdoors, as either doubles or singles. The rules are relatively simple and the game is easy for beginners to learn. However, among skilled players, pickleball can develop into a quick, fast-paced, and competitive game.

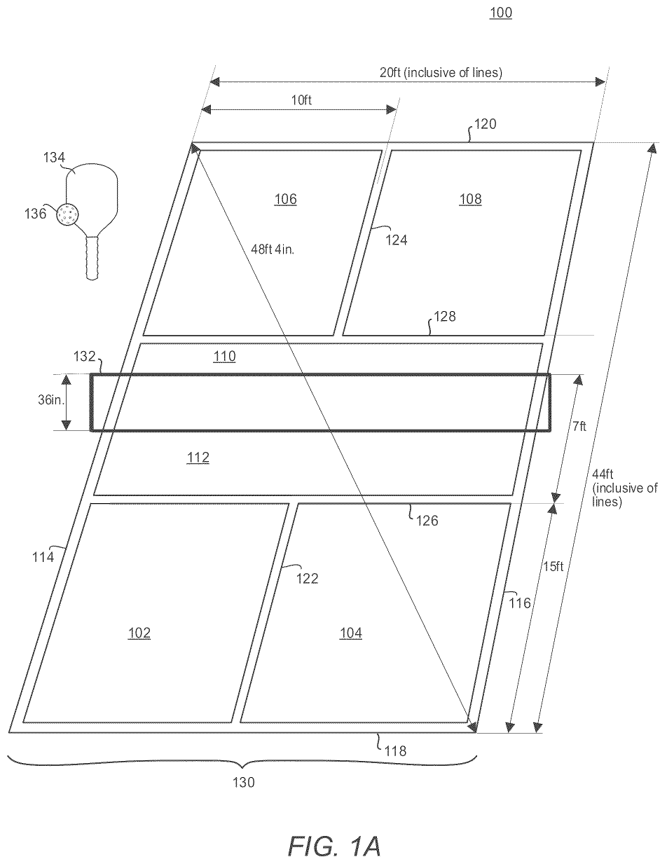

FIG. 1A shows an example pickleball court 100 that includes a pickleball playing surface 130 and a pickleball net 132. The playing surface 130 comprises two left serve areas 102 and 108, two right serve areas 104 and 106, and two non-volley areas 110 and 112, with one of the left serve areas, one of the right serve areas, and one of the non-volley areas being on each side of the pickleball net 132. The net is 36 inches tall at the edges, and lowered to 34 inches in the middle. The areas 102-112 are defined by baselines 118 and 120 each 20 feet, sidelines 114 and 116 each 44 feet, center lines 122 and 124 each 15 feet, and non-volley lines 126 and 128 each the same size as a baseline. Each of the lines may be 2 inches wide. The term “court line” is used in this disclosure to refer to any sideline, baseline, centerline or non-volley line on the pickleball court. Non-volley areas 110 and 112, each extending 7 feet from the net, are also referred to as the “kitchen”.

The game of pickleball is played with a pickleball paddle 134 and pickleball ball 136. The ball 136 is typically made of plastic and has a 3-inch diameter. Similar to a wiffleball, the ball 136 has through holes throughout the surface. Different types (e.g., with different levels of hardness and different sizes of the through holes) may be used for playing the game on the various types of pickleball courts (e.g., indoor, outdoor, hard surface, soft surface etc.).

Pickleball can be played as singles or doubles, and is most commonly played as doubles. Each point begins with an underarm serve. The serve is performed diagonally beginning at the right-hand service square. A valid serve sends the ball from one left serve area to the other left serve area or from one right serve area to the other right serve area. The serve must clear the non-volley-zone. The serve must bounce before being hit by the receiver. The return of serve must also bounce before being hit (this is known as the 2 bounce rule). After the serve and the return of the serve, the ball can land anywhere on the opposite side of the playing surface 130. Volleys can only be performed outside of the non-volley zone. Volleys, that is, hitting the ball in the air without first letting it bounce, can only be made after the 2 bounce rule has been followed. However, if the ball is hit from within the kitchen, then it cannot land in the kitchen on the other side of the net.

A fault is any action that stops play due to a rule violation. A fault by the receiving team results in the servers earning a point. A fault by the serving team results in the server's loss of service and/or side out. A fault is committed when the serve touches any part of the non-volley zone (including the line) or the ball is hit out of bounds.

Pickleball games are typically played without a referee and are self-judged. Each player makes the line calls as to whether the ball is in or out when the ball contacts the playing surface on that player's side. The game continues to at least 11 points and requires a 2-point difference for a win. FIG. 1B shows another view of a pickleball court.

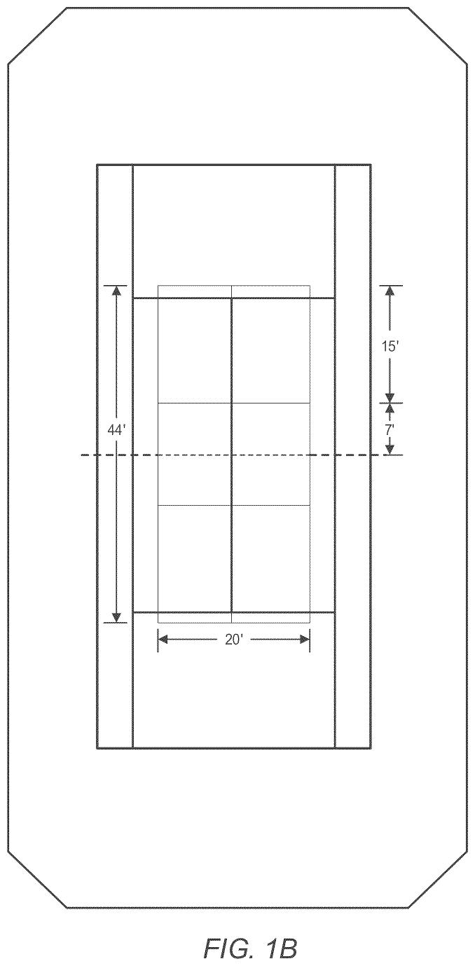

FIG. 2 illustrates an example pickleball ball 200. The pickleball ball includes a plurality of apertures 202 spread throughout its surface. There are different varieties of pickleballs. For example, pickleball balls may be manufactured using rotational molding or injection molding. Rotational molding may comprise pouring plastic into a mold, gyrating it, and drilling holes when it is firm. Injection molding may comprise pouring plastic over a mold that already has holes. Then two halves of the pickleball ball may be glued together. Pickleball balls may have a diameter of 2.87-2.97 inches (73-75.5 mm) and a circumference of 9.03-9.34 inches (22.93-23.72 cm). Pickleball balls may weigh between 0.78-0.935 oz (22-26.5 g). Indoor pickleball balls may weigh 24 g (0.855 oz) and have a diameter of 2.87 inches (7.30 cm), while outdoor pickleball balls typically weigh 25.5 g (0.9 oz) and have a diameter of 2.897 inches (7.36 cm). In an example, the maximum out-of-round diameter variance for a pickleball ball may not exceed +/−0.020 inch (0.51 mm). Pickleball balls may have different sized apertures. For example, outdoor pickleball balls may have apertures of about 10 mm in diameter. For example, indoor pickleball balls may have apertures of about 8 mm in diameter. Some pickleball balls may have a mixture of smaller and larger apertures. In an example, the diameter of pickleball ball apertures may range from about 5 mm to about 12 mm in diameter.

When playing the sport of pickleball, users hit pickleball balls with pickleball paddles. In a pickleball arena where there are multiple pickleball courts, it is not safe and/or convenient to have the balls spread around the court. There is a need to store pickleball balls in one or more places so that players can use them for playing the game.

Typically, a basket, a bucket or a tube shape pickleball ball holder is used to store or hold pickleballs. People can also hold balls in their pockets or sport apparel so that they can store and carry pickleball balls as they move around. The current solutions are inconvenient to use. For example, a basket or a bucket for storing and holding pickleball balls take up space on or around the court. The tube shape pickleball ball holders are not convenient to use as they typically have low capacity. Longer tubes with higher capacity are not easy to use as the distance between the two ends of the tube is high and both ends of the tube should be accessible. Holding pickleball balls in sports pockets and sports apparel is inconvenient for the players. Apparel holding pickleball balls are inconvenient to carry and may have a complex design and low capacity. As they are designed to snugly hold the ball when the person carrying the apparel is moving around. They are designed so that the pickleball balls do not fall out during play when the person is moving around. Also, one player has access to the balls and one apparel holder cannot typically be used by multiple players.

There is a need to design pickleball ball holders that are more convenient to use, do not take up much space in or around the court, are scalable, and can be easily installed around the court or other places. There is a need to design pickleball ball holders that may be shared by multiple players playing on one or more courts and are suitable for different types of pickleball balls with various aperture sizes. Pickleball balls should be easily stored and picked up from the pickleball ball holder. Pickleball ball holders should be scalable, and convenient to use. The example embodiments of this disclosure are configured for holding pickleball balls and meet these requirements, and provide many additional advantages. The pickleball ball holders of the example embodiments are designed to mostly remain stationary.

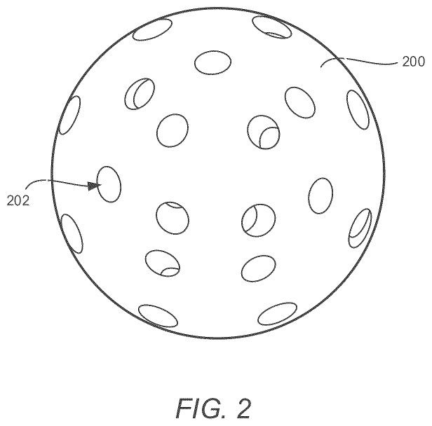

Example embodiments provide a pickleball ball holder for holding pickleballs. FIG. 3 shows an example pickleball ball holder 301. Pickleball balls have a plurality of apertures. The pickleball ball holder 301 comprises a surface board 302 and one or more projections (e.g., 304, 306) installed on the surface board to extend outwardly from the surface board. Each projection of the one or more projections is configured to hold a pickleball ball with apertures by being positioned to loosely penetrate in at least one of the apertures of the pickleball. For example, a projection 306 may hold a pickleball ball 308 as shown in FIG. 3. The thickness of the projection is smaller than the diameter of at least one of the apertures of the pickleball. The one or more projections may be designed not to compress or introduce friction to hold the pickleballs. The projection may be configured to loosely enter at least one aperture with no substantial friction. The projection may be at least partially upward to hold the pickleball. Gravity may cause the pickleball ball to loosely hold its location as long as the pickleball ball holder does not substantially move. The one or more projections may be made so as to easily bend under pressure when a person adds pressure on the one or more projections. For example, one or more projections are made of soft and bendable materials. For example, players will not be injured and will be safe if they fall on the pickleball ball holder.

The pickleball ball holder of example embodiments may be configured so as to not take up much space on or around the court. It is easy to store pickleball balls and pick up pickleball balls from the pickleball ball holder of example embodiments. Its capacity is scalable. Pickleball balls are visible when they are stored on the pickleball ball holder. The pickleball ball holder may be suitable for all types of balls with different aperture sizes as long as the thickness of the projection is smaller than the aperture diameter. As projection thickness is less than a pickleball ball aperture diameter, pickleball balls are held loose. Pickleball ball weight is used to hold the ball on the projection. Further advantages of the disclosure are apparent by reference to the detailed description when considered in conjunction with the figures.

The pickleball ball holders of example embodiments may be designed to hold pickleball balls having different sizes of apertures. For example, if the thickness of the projections in a pickleball ball holder of example embodiments is below 5 mm, then the pickleball ball holder can loosely hold different types of pickleball ball with aperture sizes of 5 mm to about 12 mm in diameter.

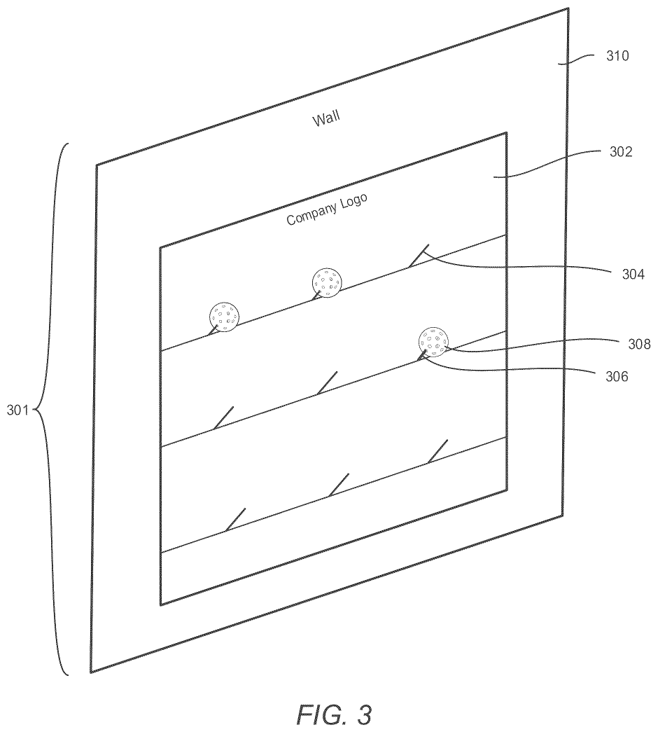

The surface board of the pickleball ball holder may be designed to be connected to another surface. For example, the surface board may be connected to another surface such as a surface of a wall, of a board, or of a fence. The surface board may be connected to another surface using screws, nails, Velcro stickers, glues, hooks, and/or the like. Embodiments are not limited by the type of surface to which the pickleball ball holder can be connected. A company logo, name, or other texts may be printed on the surface board. The surface board is designed to hold one or more projections that hold pickleballs. FIG. 3 shows the surface board 302 of the holder 301 installed onto the wall 310. The surface board of the pickleball ball holder may be attached to a fence or another board. In an example, a pickleball ball holder may be designed without a surface board. In the example, the projections may be installed on a wall, on a fence, and/or the like without a surface board. For example, a projection may be directly screwed into a wall. FIG. 4 shows another example pickleball ball holder 401 comprising a surface board 402 and a plurality of projections 404. A projection 404 may have at least a partially curved shape. One or more of the projections 404 may include a soft head 405. The soft head 405 may have a diameter that is smaller than the pickleball ball apertures and larger than the thickness of the projection. The soft head 405 facilitates holding ball(s) that are on the projection 404 without letting them slide off the projection.

The projections are configured to hold one or more pickleballs. Figures depict examples of shapes for the projections. The length of the projections is long enough to loosely hold a pickleball ball when they enter one or more apertures of the pickleball. They go sufficiently deep in an aperture of the pickleball ball so that when gravity pushes the ball on the projection, the projection can loosely hold the ball. The thickness of the projection may be designed to be less than the diameter of the aperture so that the projection can easily enter a pickleball ball aperture. The pickleball ball holder is designed to remain mostly stationary. The pickleball balls loosely hang over the pickleball ball holder and are retained by the projection. The pickleball balls can be easily put and picked up from the pickleball ball holder without applying pressure. The pickleball ball may wobble or move relative to the projection while it is retained by the projection but will not fall out easily until it is picked up by a player.

The projections may comprise a base that connects to the surface board (if any) and a soft head and extend through the surface board. The base may be secured to the surface board by adhesive, screws, pressure, welding, and/or the like. The projections may be manufactured to be a part of the surface board. The projections may be manufactured as a part of the surface board or may be configured to be added to the surface board. The projections may be fixed to and extend away from the surface board. They are positioned to be separate from each other to conveniently hold a pickleball. Pickleball balls can be inserted or picked up individually.

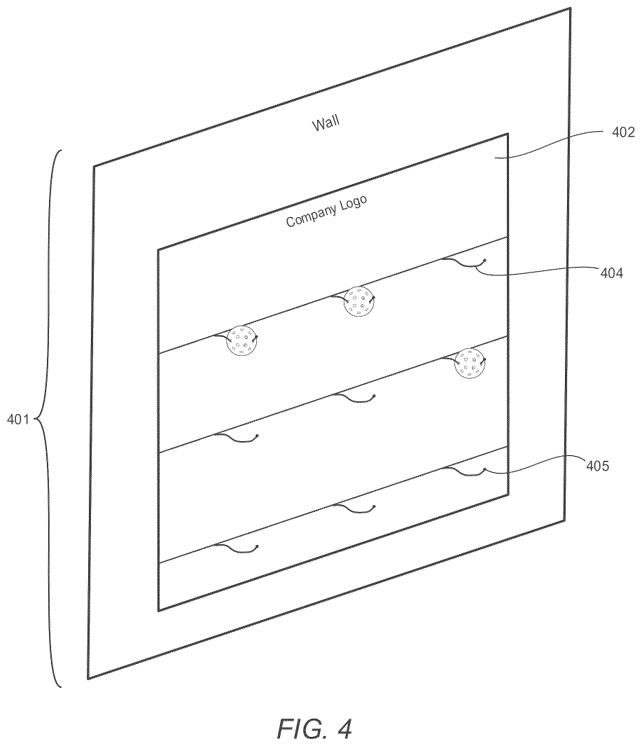

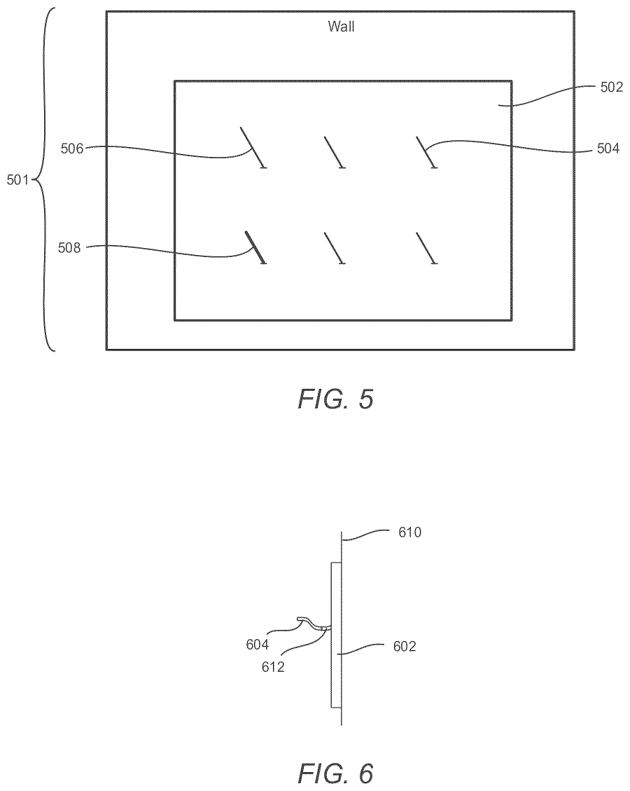

The projections may extend at least partially upward to hold the pickleballs. FIG. 5 shows a pickleball ball holder 501 with projections (e.g., 504) that are turned upward (as represented when the surface board 502 is vertical or substantially vertical) at an angle. FIG. 6 illustrates another example projection 604 where the front end of the projection is turned upwards. In an example, the projections may extend perpendicularly away from the surface board. The projections may not extend downward, as the balls may slip from the projection and fall. The projections may be of any shape, like a straight line, a bent line, a curve, spiral shape and/or the like. At least a part of the projection may be bent upward to hold the pickleball. In an example, the pickleball ball holder may be made without a surface board and the projections described above are directly connected to the wall, fence or a board. The projection may not be compressed when the projection enters a pickleball ball aperture, or when the pickleball ball is picked up from the pickleball ball holder. The pickleball ball remains loose in the holder but is stable as long as the holder does not rapidly move around. This enables convenient removal or placement of pickleballs in the pickleball ball holder.

The projections may be configured to have an elongate shape. The projections may be made of soft materials that are compressible so as to compress/flex when pressed by a human or other objects. They should substantially return to their original shape after a pressure is released. The projections may be smooth and made with rubber or plastic materials that does bend upon pressure and do not easily break. This makes the pickleball ball holder safe on and around the court. The projections are designed to easily and loosely enter a pickleball aperture without creating friction. They can easily hold pickleball balls with apertures that have a diameter larger than the thickness of the projection.

The surface board and/or projections may be made of lightweight molded plastic, rubber, silicon, and/or the like. The surface board could be made of hard materials such as wood, metal, or firm plastic. The projections are configured to loosely hold the balls until removed by a player. The quantity of projections on a surface board may vary depending on the capacity of the pickleball ball holder. The quantity may be one, two, five, ten, or more as needed to hold a quantity of pickleball balls.

FIG. 5 also illustrates an example of a surface board 502 that has some different types of projections 504, 506 and 508. Projection 508 may be thicker (i.e. larger width) than projection 504, and thus configured for holding larger aperture pickleballs than projection 504. Projection 506 may be longer than the projection 504, and thus configured to hold more pickleballs than projection 504. FIG. 6 shows an example projection 604 of which the base 612 that connects to the surface board 602. The base may be made of a flexible material and/or hinge that facilitates the projection 604 to bend if force is applied (e.g., a person accidentally running onto the projection), and return to the original orientation. The surface board 602 may be attached to a wall 610 or other surface.

The above described embodiments of the present disclosure provide a cost effective, space-efficient, safe, and easy to use pickleball ball holder. It should be noted that embodiments of the present disclosure are not limited to the shapes, sizes and construction materials of the surface boards or the shapes, lengths, thicknesses, pattern of arrangement and construction materials of the projections. Embodiments are not limited by the number of projections, the types and/or structures of projections, and a pattern of arrangement of the projections on the surface board. Although various embodiments have been shown and described in detail, the claims are not limited to any particular embodiment or example.

1. A pickleball ball holder, comprising:
a surface board;
one or more projections installed on the surface board to extend outwardly from the surface board, wherein:
a projection of the one or more projections is configured to hold a pickleball ball by being positioned to penetrate in at least one aperture of the pickleball ball;
a thickness of the projection is smaller than a diameter of the at least one of the apertures;
the projection is configured to loosely enter the at least one aperture without substantial friction.

2. The pickleball ball holder of claim 1, wherein the projection is configured to be, when the surface board is positioned vertically, at least partially upward to hold the pickleball ball.

3. The pickleball ball holder of claim 2, wherein a width of the projection is configured to, when the surface board is positioned vertically, provide for a pickleball ball arranged with the projection inserted through two apertures of the pickleball ball slide freely down the projection.

4. The pickleball ball holder of claim 1, wherein the one or more projections are configured to bend in response to a force imposed on the one or more projections.

5. The pickleball ball holder of claim 4, wherein the projection is constructed with a flexible material.

6. The pickleball ball holder of claim 4, wherein base of the projection is constructed with a flexible material different from a material of a rest of the projection.

7. The pickleball ball holder of claim 1, wherein a first projection and a second projection of the one or more projections have different thicknesses.

8. The pickleball ball holder of claim 1, wherein a first projection and a second projection of the one or more projections have different lengths.

9. The pickleball ball holder of claim 1, wherein a first projection and a second projection of the one or more projections have different shapes.

10. The pickleball ball holder of claim 9, wherein the lengths of first projection and the second projection are configured for respectively different numbers of pickleball balls.

11. The pickleball ball holder of claim 1, wherein the one or more projections comprise a plurality of projections that are arranged evenly spaced from each other on the surface board.

12. The pickleball ball holder of claim 1, wherein the projection has at least two different widths at different heights from the surface board.

13. The pickleball ball holder of claim 1, wherein the projection is configured to be, when the surface board is positioned vertically, extending in the horizontal direction.

14. The pickleball ball holder of claim 1, wherein the projection is configured to be, when the surface board is positioned vertically extending in a direction lower the horizontal direction.

15. The pickleball ball holder of claim 14, wherein an end portion of the projection is curved so as to prevent a pickleball ball that is held by the projection from falling.
